(19) United States
(12) Patent Application Publication
(10) Pub. No.: US 2008/0184970 A1
(43) Pub. Date: Aug. 7, 2008

(54) FUEL PUMP MODULE AND METHOD OF PRODUCING THE SAME

(75) Inventors: Ryuji IGARASHI, Kariya-city (JP); Katsuhisa YAMADA, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/024,308

(22) Filed: Feb. 1, 2008

(30) Foreign Application Priority Data
Feb. 5, 2007 (JP) 2007-25941

(51) Int. Cl. F02M 37/04

(52) U.S. Cl. 123/509; 29/888.02

(57) ABSTRACT

A fuel pump module includes a cylindrical sub-tank having an open portion at one end and a bottom portion at the other end, and a fuel pump located in the sub-tank. The bottom portion of the sub-tank is provided with an introducing passage from which fuel is introduced into the sub-tank, and a bottom portion of the fuel pump is provided with a suction port through which the fuel outside of the sub-tank is drawn into the sub-tank In the fuel pump module, a guide member is provided in at least one of the sub-tank and the fuel pump to guide the suction port of the fuel pump to the introducing passage of the sub-tank when the fuel pump is inserted from the open portion of the sub-tank toward the bottom portion of the sub-tank and is assembled to the sub-tank.

### CROSS REFERENCE TO RELATED APPLICATION

This application is based on Japanese Patent Application No. 2007-025941 filed on Feb. 5, 2007, the contents of which are incorporated herein by reference in its entirety.

### BACKGROUND OF THE INVENTION

1. Field of the Invention

The present invention relates to a fuel pump module, and a method of producing the fuel pump module.

2. Description of the Related Art

U.S. Pat. No. 5,596,970 describes a fuel pump module that can stably supply fuel even when a residual amount of fuel in a fuel tank is reduced. The fuel pump module has a sub-tank for accommodating a fuel pump. The fuel pump supplies the fuel in the sub-tank to an internal combustion engine while drawing the fuel of the fuel tank into the sub-tank. A bottom portion of the fuel pump is provided with a first suction port for drawing the fuel within the sub-tank, and a second suction port for drawing the fuel outside of the sub-tank. The second suction port is formed to communicate with a fuel introducing passage that is provided in a bottom portion of the sub-tank to introduce the fuel into the sub-tank.

Because the second suction port connected with the fuel introducing passage of the sub-tank is located at the bottom portion of the fuel pump, it is difficult for an operator to watch the fuel introducing passage of the sub-tank and the second suction port of the fuel pump when the fuel introducing passage of the sub-tank and the second suction port of the fuel pump are connected.

### SUMMARY OF THE INVENTION

In view of the foregoing problems, it is an object of the present invention to provide a fuel pump module or/ and a method of producing a fuel pump module, which can improve assembling property between a sub-tank and a fuel pump.

It is an object of the present invention to provide a fuel pump module or/and a method of producing a fuel pump module, which can easily and accurately connect a fuel suction port of a fuel pump and a fuel introducing passage of a sub-tank.

According to an aspect of the present invention, a fuel pump module includes a cylindrical sub-tank to be located in a fuel tank and having an open portion at one end and a bottom portion at the other end, and a fuel pump disposed in the sub-tank. The bottom portion of the sub-tank is provided with an introducing passage from which fuel is introduced into the sub-tank, and a bottom portion of the fuel pump is provided with a suction port through which the fuel outside of the sub-tank is drawn into the sub-tank. Furthermore, the suction port is connected to the intruding passage of the sub-tank. In the fuel pump module, a guide member is provided in at least one of the sub-tank and the fuel pump, and the guide member is configured to guide the suction port of the fuel pump to the introducing passage of the sub-tank when the fuel pump is inserted from the open portion of the sub-tank toward the bottom portion of the sub-tank and is assembled to the sub-tank. Accordingly, even when the suction port of the fuel pump and the introducing passage of the sub-tank are not seen by an operator, the suction port of the fuel pump can be easily accurately connected to the introducing passage of the sub-tank by using the guide member when the fuel pump is assembled to the sub-tank.

For example, the guide member may be provided between an inner wall of the sub-tank and a side wall of the fuel pump, or a plurality of the guide members may be provided approximately at equal distant in a circumferential direction of the fuel pump.

The guide member may include a first engagement portion provided at the sub-tank, and a second engagement portion provided at the fuel pump. Furthermore, the first engagement portion and the second engagement portion may be engaged with each other to restrict a movement of the fuel pump in a radial direction and in a circumferential direction of the fuel pump in this case, one of the first engagement portion and the second engagement portion may have a protruding portion protruding and extending in an axial direction of the fuel pump.

Alternatively, the guide member may include a first engagement portion provided at one of the sub-tank and the fuel pump, and a second engagement portion provided at the other one of the sub-tank and the fuel pump, and the first engagement portion and the second engagement portion may be engaged with each other to restrict a movement of the fuel pump in a radial direction and in a circumferential direction of the fuel pump Furthermore, the first engagement portion may have a protruding portion protruding and extending in an axial direction of the fuel pump, and the second engagement portion may have an insertion portion that is open in the axial direction. In this case, the protruding portion of the first engagement portion is engaged with the insertion portion of the second engagement portion.

According to another aspect of the present invention, a method of producing a fuel pump module includes a step of forming a cylindrical sub-tank having an open portion at one end and a bottom portion at the other end in an axial direction, a step of forming a fuel pump having a bottom portion provided with a suction port through which the fuel outside of the sub-tank is drawn into the sub-tank, and a step of inserting the fuel pump into the sub-tank from the open portion of the sub-tank while being guided by a first engagement of the fuel pump and a second engagement portion of the sub-tank. In the method, the first engagement portion and the second engagement portion are engaged with each other when the fuel pump is inserted into the sub-tank and is assembled with the sub-tank. Furthermore, the suction port of the fuel pump is guided by the guide member to an introducing passage of the bottom portion of the sub-tank and is connected to the introducing passage of the sub-tank while the first engagement portion and the second engagement portion are engaged. Accordingly, even when the suction port of the fuel pump and the introducing passage of the sub-tank are not seen by an operator, the suction port of the fuel pump can be easily accurately connected to the introducing passage of the sub-tank by using the guide member when the fuel pump is assembled to the sub-tank.

### BRIEF DESCRIPTION OF THE DRAWINGS

Additional objects and advantages of the present invention will be more readily apparent from the following detailed description of preferred embodiments when taken together with the accompanying drawings. In which:

FIG. 1 is a schematic sectional view showing a fuel pump module according to a first embodiment of the present invention;

FIG. 2 is a top view when being viewed from the arrow II in FIG. 1;

FIG. 3 is a disassembled perspective view showing a part of the fuel pump module shown in FIG. 1;

FIG. 4 is a disassembled perspective view showing a part of a fuel pump module according to a second embodiment of the present invention; and

FIG. 5 is a perspective view showing a part of a fuel pump module according to a modification of the second embodiment of the present invention.

### DETAILED DESCRIPTION OF THE PREFERRED EMBODIMENTS

### First Embodiment

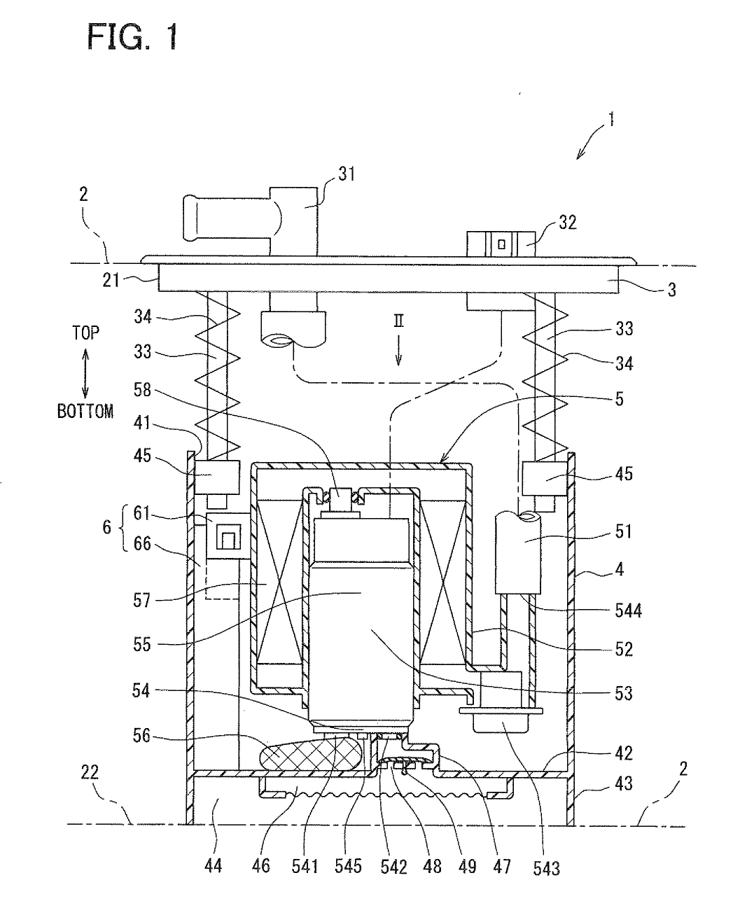

A first embodiment of the present invention will be described with reference to FIGS. 1 to 3. FIG. 1 shows a state where a fuel pump module 1 is disposed in a fuel tank 2. In FIG. 1, the top-bottom direction is a gravity direction of the fuel tank 2 mounted on a vehicle. The fuel pump module 1 is configured to supply fuel in the fuel tank 2 to an exterior portion of the fuel tank 2, for example, an internal combustion engine.

The fuel pump module 1 is inserted into the fuel tank 2 from an open portion 21 of the fuel tank 2, and is disposed in the fuel tank 2. The fuel pump module 1 is located on a bottom surface 22 of the fuel tank 2. A flange 3 is fitted in the open portion 21 to close the open portion 21.

The fuel pump module 1 is constructed by assembling a sub-tank 4, a pump unit 5, and the like. The sub-tank 4 is accommodated in the fuel tank 2, and the pump unit 5 is located in the sub-tank 4. The flange 3 and the sub-tank 4 are coupled to each other by using shafts 33.

The flange 3 is made of a resin material, and is formed into approximately a circular shape. The flange 3 is molded integrally with a fuel discharge pipe 31 and an electrical connector 32 by using the resin material. The fuel discharge pipe 31 is connected to the pump unit 5 via a hose 51 such that the fuel discharged from the pump unit 5 is discharged to the exterior portion of the fuel tank 2 through the hole 51 and the fuel discharge pipe 31.

The electrical connector 32 is electrically connected to an electrical connector (not shown) provided in the pump unit 5 via a lead line (not shown) or the like, such that electrical power from the electrical connector 32 is supplied to the pump unit 5 via the lead line (not shown).

The shafts 33 are fixed to the flange 3 on a side of the sub-tank 4 so that the flange 3 is connected to the sun-tank 4 through the shafts 33. In this embodiment, two shafts 33 are fitted into the flange 3, as an example. One-side end portions of the two shafts 33 are fitted into the flange 3, and the other-side end portions of the two shafts 33 are connected to the sub-tank 4.

The sub-tank 4 can be made of a resin material. The sun-tank 4 is formed generally in a cylindrical shape having an open portion 41 at its top and a bottom surface 42 at its bottom. Insertion portions 45, into which the shafts 33 are inserted, are provided on an inner wall of the sub-tank 4. The shafts 33 are movably inserted into the insertion portions 45 to be movable in the insertion portions 45 in an axial direction of the sub-tank 4.

A coil-shape spring 34 is provided on the outer peripheral surface of each shaft 33. One end of the spring 34 is supported to the flange 3, and the other end is supported to the insertion portion 45. The sub-tank 4 is pushed to the bottom surface 22 of the fuel tank 2 by elastic force of the springs 34. The height of the bottom surface of the fuel tank 2 may be changed by an expansion or contraction of the fuel tank 2 due to a variation in an interior pressure, a variation in a temperature, or a variation of a fuel amount, etc. However, in this embodiment, even when the bottom surface of the sub-tank 4 is changed in accordance with the change of the height of the bottom surface 22 of the fuel tank 2, the structure of the shafts 33 using the springs 34 can be followed to the variation in the height of the bottom surface 42 of the sub-tank 4.

The bottom surface 42 of the sub-tank 4 is provided with a leg portion 43. The leg portion 43 is formed to extend from the bottom surface 42 of the sub-tank 4 to the bottom surface 22 of the fuel tank 2 so that a clearance (space portion) 44 is formed between the bottom surface 42 of the sub-tank 4 and the bottom surface 22 of the fuel tank 2. An open portion 48 is formed at the bottom surface 42, and a fuel introducing passage 47 is formed in a bottom portion of the sub-tank 4 to be open to the open portion 48. Through the fuel introducing passage 47 and the open portion 48, the interior of the sub-tank 4 communicates with an exterior of the sub-tank 4 within the tank portion 2. A check valve 49 is located at the open portion 48 so that the fuel outside of the sub-tank 4 flows into the interior of the sub-tank 4 via the check valve 49. The fuel introducing passage 47 is connected to a suction port of an electrical fuel pump 53 described later. When the fuel pump 53 of the pump unit 5 is driven, the fuel outside of the sub-tank 4 is drawn into the sub-tank 4 through the open portion 48. A suction filter 46 is located at an upstream side of the open portion 48 so that foreign material such as dust contained in the fuel can be removed while passing through the suction filter 46.

The pump unit 5 is located and assembled into the sub-tank 4 by using a guide member 6. The guide member 6 includes engagement portions such as a holding portion 66 and a held portion 61. The pump unit 5 includes a case 52, the electrical fuel pump 53 accommodated in the case 52, a suction filter 56 located at an upstream side of the fuel pump 53, and a fuel filter 57 located at a downstream side of the fuel pump 53.

The fuel pump 53 includes a pump portion 54 having an impeller, and an electrical motor 55 for driving the pump portion 54. The pump portion 54 has therein a first pump chamber and a second pump chamber (not shown). Each of the first and second pump chambers of the pump portion 54 are provided to draw the fuel from first and second suction ports 541, 542 of the pump portion 54. The first suction port 541 is provided for drawing the fuel within the sub-tank 4, and the second suction port 542 is provided for drawing the fuel from the exterior of the sub-tank 4 within the fuel tank 2. The first suction port 541 of the pump portion 54 is connected to the suction filter 56, and the second suction port 542 is connected to the fuel introducing passage 47 provided in the bottom portion of the sub-tank 4.

When the fuel pump 53 is driven, the fuel within the sub-tank 4 is supplied to the first pump chamber through the first suction port 541, and the fuel outside the sub-tank 4 is drawn into the second pump chamber through the suction filter 46, the fuel introducing passage 47 and the second suction port 542.

The fuel drawn into the first chamber of the pump portion 54 is discharged to the fuel filter 57. The fuel flowing into the fuel filter 57 passes through a pressure regulator 543 and is discharged from a first discharge port 544. The fuel discharged from the first discharge port 544 is supplied to an exterior portion such as an internal combustion engine via the hose 51 and the fuel discharge pipe 31. When a pressure of the fuel discharged from the first chamber is equal to or higher than a predetermined value, the surplus-pressure fuel flows out of a drain port (not shown) of the pressure regulator 543, and is returned to the sub-tank 4. On the other hand, the fuel drawn into the second pump chamber is discharged from the second discharge port 545, and is drawn into the sub-tank 4.

A check valve 58 is provided in the case 52 of the pump unit 54 The check valve 58 is positioned downstream than the pump portion 54. Because the check valve 58 is located, it can prevent the fuel in the hose 51 from reversely flowing into the fuel pump 53 and from flowing out of the suction filter 56 when the operation of the fuel pump 53 is stopped. As a result, the fuel pressure within the hose 51 can be maintained to a predetermined pressure when the operation of the fuel pump 53 is stopped.

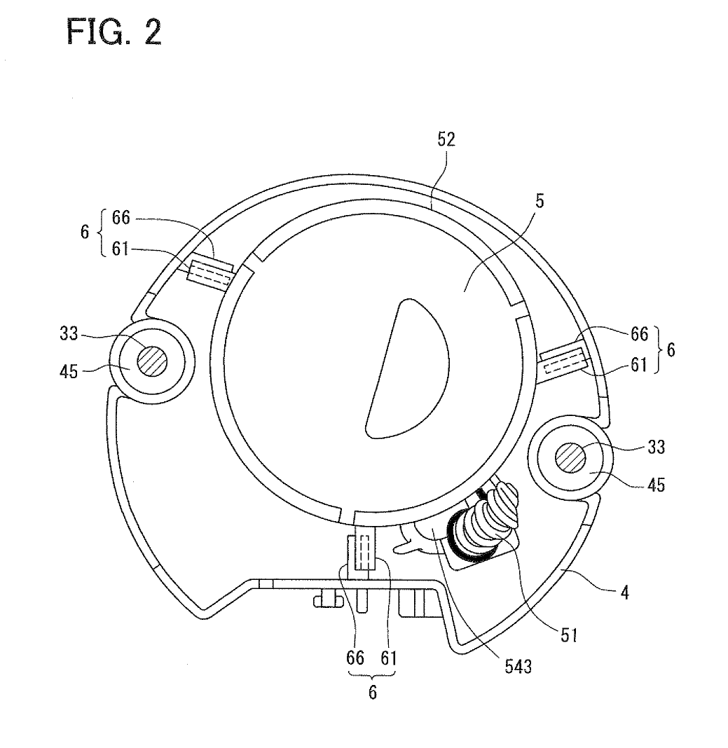

FIG. 2 is a top view when being viewed from the arrow II of FIG. 2. As shown in FIG. 2, the pump unit 5 having the fuel pump 53 is supported to the sub-tank 4 by three guide members 6, for example The guide members 6 are located substantially at equal intervals to be positioned between the case 52 of the pump unit 5 and the inner wall of the sub-tank 4. Therefore, the pump unit 5 can be stably supported to the sub-tank 4.

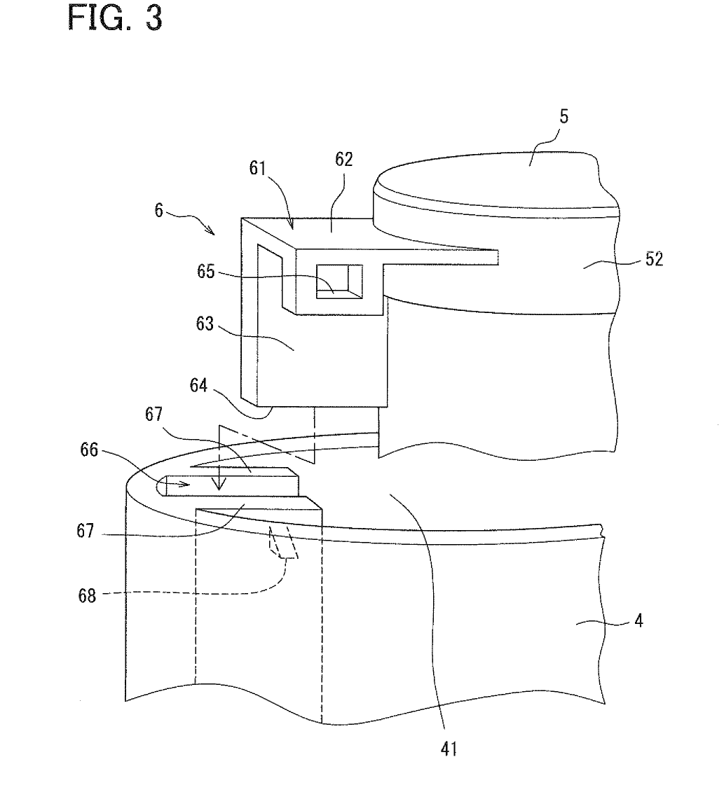

As shown in FIG. 2, each of the guide members 6 is constructed with two engagement portions, for example, the holding portion 66 and the held portion 61 in the first embodiment. The held portion 61 to be held extends from a side wall of the case 52 of the pump unit 5 toward the inner wall of the sub-tank 4. As shown in FIG. 3, the holding portion 66 for holding the held portion 61 is provided to pinch the held portion 61; and extends from the inner wall of the sub-tank 4 toward the side wall of the case 52.

FIG. 3 is a perspective view showing one of the three guide members 6 at a state before the sub-tank 4 and the pump unit 5 are assembled. As shown in FIG. 3, the held portion 61 extends radially outwardly from the side wall of the case 52 of the pump unit 5 to the inner wall of the sub-tank 4.

The held portion 61 includes a base portion 62 supported in the side wall of the case 52 and extending radially outwardly, an insertion plate 63 (protruding portion) extending from a lower end of the base portion downwardly, and an engagement hole portion 65. As shown in FIG. 35 the insertion plate 63 and the engagement hole portion 65 are provided at the base portion 62 to be opposite to each other and to be separated from each other by a predetermined clearance.

The holding portion 66 for holding the held portion 61 is formed on the inner wall of the sub-tank 4. The holding portion 66 includes two pinching plates 67 for pinching two side surfaces of the insertion plate 63 in a circumferential direction That is, the two pinching portions 67 form an insertion portion into which the insertion plate 63 is inserted. One of the two pinching plates 67 is provided with an engagement claw 68 at its outer surface to be engaged with and fitted into the engagement hole portion 65. A clearance between the two pinching plates 67 is set such that the insertion plate 63 is movable in the axial direction while the insertion plate 63 is pinched between the two pinching plates 67 in the circumferential direction. The two pinching plates 67 extending in the axial direction approximately entirely from the open portion 41 of the sub-tank 4 to the bottom surface 42 shown in FIG. 1.

Next, assemble operation of the pump unit 5 to the sub-tank 4 will be described. The pump unit 5 is inserted from the open portion 41 of the sub-tank 4, and is assembled into the sub-tank 4 such that the second suction port 542 located at the pump portion 54 of the pump unit 5 is connected to the fuel introducing passage 47 provided in the bottom portion of the sub-tank 4.

The second suction port 542 and the fuel introducing passage 47 are not watched from the outside (top side) by an operator when the pump unit 5 and the sub-tank 4 are assembled, and it is generally difficult to accurately connect the second suction port 542 and the fuel introducing passage 47 for a short time. However, in the first embodiment, the second suction port 542 and the fuel introducing passage 47 can be easily and accurately connected by using the guide members 6.

In this embodiment, the operator can manually hold the pump unit 5 into which the fuel pump 53 is assembled, and move it to an upper side of the open portion 41 of the sub-tank 4. Then, the lower end portions 64 of the insertion plates 63 are inserted into the insertion spaces between the pinching plates 67, respectively. In this embodiment, the lower end portions 64 of the three insertion plates 63 are respectively engaged with corresponding holding portions 66 between the pinching plates 67. At this time, the second suction port 542 of the fuel pump 53 and the fuel introducing passage 47 of the sub-tank 4 are not in a connection state.

Because the three insertion plates 67 are inserted between the pinching plates 67 at three positions, a movement of the pump unit 5 in the circumferential direction can be restricted. Furthermore, at this time, the radial side surfaces of the insertion plates 63 contact the inner wall of the sub-tank 4, a movement of the pump unit 5 in the radial direction can be also restricted.

In this state, the second suction port 542 of the fuel pump 53 is positioned on the axial line of the fuel introducing passage 47 of the sub-tank 4. Therefore, only when the pump unit 5 is moved by the operator toward the bottom surface of the sub-tank 4 while the insertion plates 63 are inserted between the pinching plates 67, respectively, the second suction port 542 of the fuel pump 53 of the pump unit 5 can be guided to the fuel introducing passage 47 of the sub-tank 4 without a fail. Then, the second suction port 542 of the fuel pump 53 of the pump unit 5 is connected to the fuel introducing passage 47 of the sub-tank 4 after the pump unit 5 is completely inserted into the sub-tank 4. Thus, the operator can easily and accurately connect the second suction port 542 and the fuel introducing passage 47 without watching it.

Then, when the second suction port 542 of the fuel pump 53 is connected with the fuel introducing passage 47, the engagement claws 68 formed in the pinching plates 67 are engaged with and fitted into the engagement hole portions 65 of the held portion 61, respectively The engagement claw 68 has a surface facing to the bottom surface 42 of the sub-tank 4. When the engagement claws 68 are engaged with and fitted into the engagement hole portions 65, respectively, a movement of the pump unit 5 to an upper side can be restricted. Accordingly, it can prevent the connected second suction port 542 of the pump unit 5 and the fuel introducing passage 47 of the sub-tank 4 from being separated. In this embodiment, the engagement hole portions 65 with the holes therein are formed to have flexibility, so that the engagement claws 58 can be easily engaged with the engagement hole portions 65.

In the above-described first embodiment, the held portions 61 are formed on the side of the pump unit 5, and the holding portions 66 are formed on the side of the sub-tank 4. However, the held portions 61 may be formed on the side of the sub-tank 4, and the holding portions 66 may be formed on the side of the pump unit 5.

In the above-described first embodiment, the insertion plate 63 and the pinching plates 67 are formed into a plate shape extending in the axial direction. However, at least one of the insertion plate 63 and the pinching plates 67 may extend in the axial direction.

Furthermore, the three guide members 6 (engagements portions) each of which is constructed with the held portion 61 and the holding portion 66 are not required to form with the same structure, but may have different structures. For example, the three insertion plates 63 may have different thickness without being limited to the same thickness. At least one of the three insertion plates 63 may be different from the other of the three insertion plates 63. In this case, the circumferential position of the pump unit 5 can be easily accurately set with respect to the circumferential position of the sub-tank 4. Furthermore, the circumferential distance between the insertion plates 63 of the held portions 61 may be set to be different from each other.

### Second Embodiment

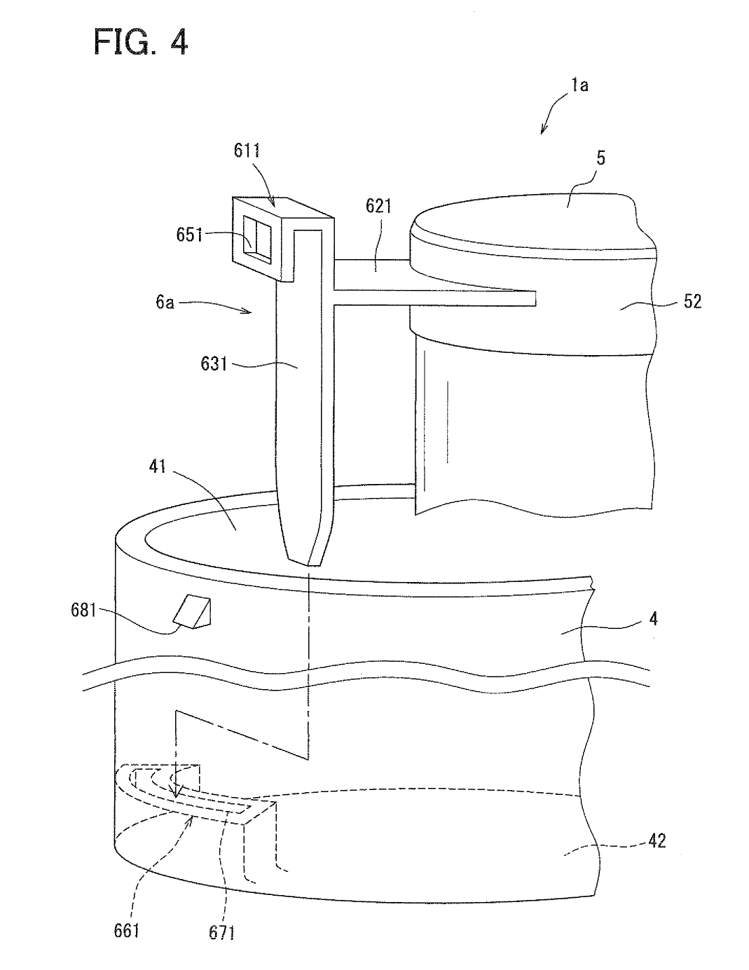

A second embodiment of the present invention will be described with reference to FIG. 4. FIG. 4 shows a guide member 6a of a fuel pump module 1a in a state before the pump unit 5 is assembled to the sub-tank 4. As shown in FIG. 4, the guide member 6a includes a held portion 611 formed at the case 52 of the pump unit 5, and a holding portion 661 formed at the sub-tank 4. The held portion 611 extends radially from the side wall of the case 52 of the pump unit 5 toward the inner wall of the sub-tank 4. The held portion 611 includes a base portion 621, an insertion portion 631 and an engagement hole portion 651. The base portion 621 is held by the side wall of the case 52 at one end, and extends radially outwardly toward the inner wall of the sub-tank 4. The insertion plate 631 extends downwardly from the other end of the base portion 621, and the engagement hole portion 651 is located to be spaced from the insertion plate 631 by a predetermined distance at a position radially outside from the insertion plate 631. The engagement hole portion 651 has therein a hole to be engaged and fitted.

The holding portion 661 is formed to extend from the bottom surface 42 of the sub-tank 4 to hold the held portion 611 The holding portion 661 has an insertion hole 671 into which the insertion plate 631 is inserted. By inserting the insertion plate 631 into the insertion hole 671, a movement of the pump unit 5 in the circumferential direction and in the radial direction can be restricted.

The outer wall of the subtank 4 is provided with an engagement claw 681 at a position adjacent to the open portion 41. The engagement claw 681 protrudes radially outwardly from the outer wall surface of the sub-tank 4, and is fitted into the engagement hole portion 611 after the insertion plate 631 is inserted into the insertion hole 671. When the engagement claw 681 is engaged with and fitted into the hole of the engagement hole portion 611, a movement of the pump unit 5 to an upper side can be restricted.

In the second embodiment, the engagement hole portion 651 is provided at an upper side of the base portion 621, and is formed in parallel with the insertion plate 631. However, the shape of the engagement hole portion 651 can be suitably changed only when the engagement claw 681 is fitted into the engagement hole portion 651 after the insertion plate 631 is inserted into the insertion hole 671.

According to the second embodiment, by engaging the held portion 611 with the holding portion 661, the second suction port 542 of the fuel pump 53 and the fuel introducing passage 47 of the sub-tank 4 can be easily accurately connected although the second suction port 542 of the fuel pump 53 and the fuel introducing passage 47 of the sub-tank 4 are not watched by the operator, similarly to the above-described first embodiment.

Furthermore, similarly to the above-described first embodiment, the held portion 611 to be held may be located at the side of the sub-tank 4, and the holding portion 661 for holding may be located at the side of the pump unit 5.

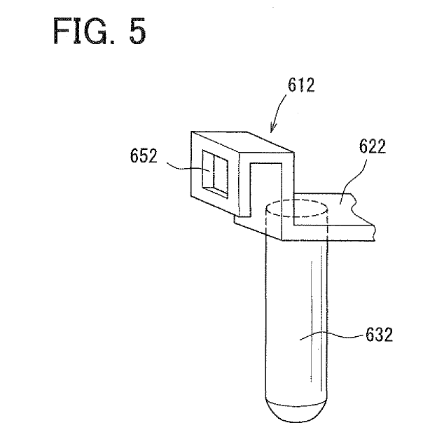

Furthermore, instead of the held portion 611 of the second embodiment, a held portion 612 shown in FIG. 5 may be used. The held portion 612 shown in FIG. 5 has a cylindrical insertion pin 632 extending downwardly of a base portion 622, instead of the insertion plate 631 formed at the base portion 621 shown in FIG. 4.

In the modification of the second embodiment shown in FIG. 5, the held portion 612 includes the base portion 622, the insertion pin 632 and an engagement hole portion 652. The base portion 622 is held in the side wall of the case 52 at one end, and extends radially outwardly from the side wall of the case 52. The insertion pin 632 extends downwardly from the other end portion of the base portion 622, and the engagement hole portion 652 is located at an upper side of the base portion 622 at a position radially outwardly from the insertion pin 632. The engagement hole portion 652 has therein a hole to be engaged and fitted. In the modification shown in FIG. 5, the insertion hole into which the insertion pin 632 is inserted can be formed approximately into a cylindrical shape in the sub-tank 4

Accordingly, in the second embodiment and the modification thereof, the same advantages described in the above first embodiment can be obtained.

### Other Embodiments

Although the present invention has been fully described in connection with the preferred embodiments thereof with reference to the accompanying drawings, it is to be noted that various changes and modifications will become apparent to those skilled in the art.

For example, in the above-described embodiments, the guide members 6, 6a are formed at three positions in the circumferential direction. However, a single guide member 6, 6a may be located. Even in this case, it is possible to easily connect the second suction port 542 of the fuel pump 53 and the fuel introducing passage 47 of the sub-tank 4, by using the single guide member 6, 6a. Furthermore, plural guide members equal to two or more than three may be used.

In the above-described embodiments, the engagement portions such as the held portion 61, 611, 612 and the holding portion 66, 661 are used as the guide member 6a for guiding the suction port (second suction port 542) of the fuel pump 53 to the fuel introducing passage 47 of the sub-tank 4 when the fuel pump 53 is inserted from the open portion 41 of the sub-tank 4 toward the bottom portion of the sub-tank 4 and is assembled to the sub-tank 4. However, the other engagement structure may be used as the guide member 6, 6a, and the guide member 6, 6a may be provided in at least one of the sub-tank 4 and the fuel pump 53, only when the guide member 6, 6a is configured to guide the suction port 542 of the fuel pump 53 to the fuel introducing passage 47 of the sub-tank 4 when the fuel pump 53 is assembled to the sub-tank 4.

Such changes and modifications are to be understood as being within the scope of the present invention as defined by the appended claims.

What is claimed is:

1. A fuel pump module comprising:
a cylindrical sub-tank to be located in a fuel tank and having an open portion at one end and a bottom portion at the other end, the bottom portion being provided with an introducing passage from which fuel is introduced into the sub-tank;
a fuel pump disposed in the sub-tank and having a bottom portion provided with a suction port through which the fuel outside of the sub-tank is drawn into the sub-tank, the suction port being connected to the intruding passage of the sub-tank; and
a guide member provided in at least one of the sub-tank and the fuel pump,
wherein the guide member is configured to guide the suction port of the fuel pump to the introducing passage of the sub-tank when the fuel pump is inserted from the open portion of the sub-tank toward the bottom portion of the sub-tank and is assembled to the sub-tank.

2. The fuel pump module according to claim 1, wherein the guide member is provided between an inner wall of the sub-tank and a side wall of the fuel pump.

3. The fuel pump module according to claim 1, wherein a plurality of the guide members are provided between an inner wall of the sub-tank and a side wall of the fuel pump.

4. The fuel pump module according to claim 1, wherein a plurality of the guide members are provided approximately at equal distant in a circumferential direction of the fuel pump.

5. The fuel pump module according to claim 1, wherein:
the guide member includes a first engagement portion provided at the sub-tank, and a second engagement portion provided at the fuel pump;
the first engagement portion and the second engagement portion are engaged with each other to restrict a movement of the fuel pump in a radial direction and in a circumferential direction of the fuel pump; and
one of the first engagement portion and the second engagement portion has a protruding portion protruding and extending in an axial direction of the fuel pump.

6. The fuel pump module according to claim 1, wherein the guide member has a fit portion which is configured to restrict a movement of the fuel pump to a side of the open portion in a state where the suction port of the fuel pump is connected to the introducing passage of the sub-tank.

7. The fuel pump module according to claim 1, wherein:
the guide member includes a first engagement portion provided at one of the sub-tank and the fuel pump, and a second engagement portion provided at the other one of the sub-tank and the fuel pump;
the first engagement portion and the second engagement portion are engaged with each other to restrict a movement of the fuel pump in a radial direction and in a circumferential direction of the fuel pump;
the first engagement portion has a protruding portion protruding and extending in an axial direction of the fuel pump, and the second engagement portion has an insertion portion that is open in the axial direction; and
the protruding portion of the first engagement portion is engaged with the insertion portion of the second engagement portion.

8. The fuel pump module according to claim 7, wherein:
the first engagement portion further has a base portion extending in a radial direction, and an engagement hole portion located at the base portion opposite to the protruding portion, the protruding portion being provided to extend from the base portion in the axial direction; and
the second engagement portion further has an engagement claw that is fitted into the engagement hole portion.

9. The fuel pump module according to claim 7, wherein;
the first engagement portion is provided at a case portion of the fuel pump; and
the second engagement portion is provided at the sub-tank on the inner wall of the sub-tank.

10. The fuel pump module according to claim 9, wherein:
the insertion portion of the second engagement portion is provided to extend from the bottom portion to a predetermined position in the axial direction; and
the protruding portion of the first engagement portion is located at the case portion of the fuel pump, and extends approximately entirely from the open portion of the sub-tank to the bottom portion of the sub-tank in the axial direction.

11. The fuel pump module according to claim 7 wherein
the suction portion of the fuel pump is connected to the introducing passage of the sub-tank when the protruding portion of the first engagement portion is engaged with the insertion portion of the second engagement portion.

12. A method of producing a fuel pump module, comprising:
forming a cylindrical sub-tank having an open portion at one end and a bottom portion at the other end in an axial direction, the bottom portion being provided with an introducing passage from which fuel is introduced into the sub-tank;
forming a fuel pump having a bottom portion provided with a suction port through which the fuel outside of the sub-tank is drawn into the sub-tank;
inserting the fuel pump into the sub-tank from the open portion of the sub-tank while being guided by a first engagement of the fuel pump and a second engagement portion of the sub-tank, wherein:
the first engagement portion and the second engagement portion are engaged with each other, when the fuel pump is inserted into the sub-tank and is assembled with the sub-tank; and
the suction port of the fuel pump is guided to the introducing passage of the sub-tank and is connected to the introducing passage of the sub-tank while the first engagement portion and the second engagement portion are engaged.

13. The method according to claim 12, wherein:
the first engagement portion has a protruding portion extending in the axial direction, and the second engagement portion has an insertion portion opened in the axial direction; and
the protruding portion of the first engagement portion is inserted into the insertion portion of the second engagement portion to restrict a movement of the fuel pump in a radial direction and in a circumferential direction when the fuel pump is inserted into the sub-tank.
